(19) United States
(12) Patent Application Publication
(10) Pub. No.: US 2018/0140936 A1
(43) Pub. Date: May 24, 2018

(54) ELECTRONIC GAME BOARD

(71) Applicant: Brian Hovey, Stewartville, MN (US)

(72) Inventor: Brian Hovey, Stewartville, MN (US)

(21) Appl. No.: 15/358,249

(22) Filed: Nov. 22, 2016

(51) Int. Cl. A63F 3/00; A63F 3/04; A63F 1/00; A63F 3/02; A63F 9/04; A63F 13/2145; A63F 13/24

(52) U.S. Cl. CPC A63F 3/00643; A63F 2001/001; A63F 3/0423; A63F 3/0421; A63F 1/00; A63F 3/02; A63F 9/04; A63F 3/00154; A63F 3/00151; A63F 3/00094; A63F 13/2145; A63F 13/24; A63F 2003/0426; A63F 2001/005; A63F 2001/003; A63F 2001/006; A63F 2250/52; A63F 3/00006

(57) ABSTRACT

An electronic table top game board that includes: an interface area, where the interface area adapts to a predetermined configuration based on user input; player informational displays surrounding the interface area; and a plurality of user interactive devices. The interface area and the plurality of user interactive devices preferably include touch interactive protocol. The electronic table top game board may also include an alternative controller, where the alternative controller includes a joystick and a plurality of control buttons.

### BACKGROUND OF THE INVENTION

### Field of Invention

The present invention relates to an electronic table top game board that may be used to play a plurality of traditional board games.

### Description of Related Art

Electronic game boards are usually in a format used on a computer screen, a tablet or a hand held electronic device. These game boards essentially interface through the traditional computer format with an input device such as a mouse, joystick or electronic touch screen. However, the use of such an electronic game board is not appealing to some individuals who may enjoy traditional game boards in a table top format. A traditional game board unfolds and lays on the table top and usually has tokens or other interactive aspects such as dice that are used to determine move count. However, the drawback to the traditional game board is the maintenance required and the importance of maintaining all the pieces, cards or other assorted components of the game board. As a result, it would be advantageous to have an electronic table top game board that enables users to engage in the traditional gaming activity over an electronic surface. One advantage to the electronic game board is the ability to engage with the various types of games.

### SUMMARY OF THE INVENTION

The present invention relates to an electronic table top game board that includes: an interface area, where the interface area adapts to a predetermined configuration based on user input; player informational displays surrounding the interface area; and a plurality of user interactive devices. The interface area and the plurality of user interactive devices preferably include touch interactive protocol. The electronic table top game board may also include an alternative controller, where the alternative controller includes a joystick and a plurality of control buttons.

### BRIEF DESCRIPTION OF DRAWINGS

FIG. 1 depicts an electronic game board with the accessories in accordance with the present invention.

### DETAILED DESCRIPTION

The present invention relates to a table top electronic game board that is capable of interfacing and engaging in various games based upon input by the user. Rules and game board layout may be integrated into the electronic game board according to the present invention by using software that simulates a traditional game board format. The electronic game board according to the present invention may be implemented to partake in traditional game boards such as Scrabble, Monopoly, Clue or other game boards. Further the game board may be configured to engage in various card games such as poker, blackjack or gin rummy. As a result, a multitude of games may be implemented through the electronic game board without the need for storage of multiple boards and pieces that are associated with a traditional game board. The present electronic game board is engaged on a table top that gives a familiar set up for the users.

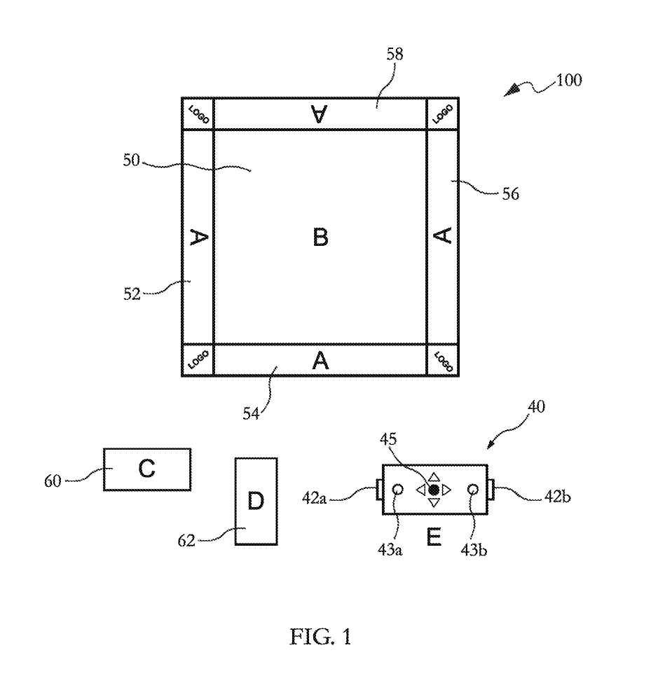

In reference to FIG. 1, an Electronic Game Board 100 is depicted. The Game Board 100 has an electronic Interface Area 50. The Interface Area 50 may be configured electronically through the implementation of appropriate software and provide a display of a traditional game board. The Interface Area 50 is depicted at the center of the Game Board 100, where four player displays 52, 54, 56, 58 surround the Interface Area 50, so a plurality of players may play on the Game Board 100 in accordance with the present invention. The player displays 52, 54, 56, 58 may include statistical information and specific game information while engaging in that game across the Interface Area 50. This statistical information may include token designation, percentage or amount of money available to a player, or chips available to a player, the display areas are controlled electronically through software provided within the Board 100. In one embodiment, the Game Board 100 may include additional ports to allow connectivity of multiple players on each side of the board. Further, the game boards may be linked or connected to one or more game boards, allowing even more players to interact and engage in a board game. The Game Board 100 may be portable or custom to fit in a table or other furniture.

The present invention includes an ability to configure the Interface Area 50 into a game board based upon input provided by software. In particular, the Interface Area may provide a digital display of various traditional game boards such as Chess, Monopoly, Scrabble, Clue, Risk, Yahtzee, Sorry, Game of Life, Trouble, Mastermind, Checkers, Chinese Checkers, Connect 4, Backgammon or a Trivial Pursuit, to name a few. Further card games may also be played such as any traditional card game with a four suits per deck such as poker, gin rummy, blackjack, solitaire, spades, bridge, or Pai Gow, to name a few. The cards may be dealt using the interactive handheld devices and shuffling of the deck will be integrated within the Interface Area 50. In terms of shuffling, the shuffle may be a random shuffle that is initiated by a dealer through the touch screen of the Interface Area 50 or randomly shuffled by computer generated.

Interactive Devices 60, 62 are hand held devices that in all are used to engage in and interact with the Game Board 50. An alternative Controller 40 is shown also in FIG. 1. The Controller 40 includes a joystick 45, a pair of knobs 40a, 40b and buttons 42a, 42b on side panels of the Controller 40. These particular items shown on Controller 40 allow interactive activity with an electronic game played on the Game Board 50. The controls also include knobs 43a, 43b and provide additional interactive sources. Another aspect of the Interface Area 50, the screen may be configured into an arcade game using the Controller 40. Such arcade games include Pacman, Street Fighter, Donkey Kong, Galaga, Candy Crush, Mine Sweeper and/or numerous other conventional arcade games.

The game board according to the present invention also may be connected wirelessly to the internet in order to download various software for play on the game board. Further aspects include a touch screen capability on the Interface Area 50 and Interactive devices 60, 62 shown in FIG. 1. As an alternative to the Interactive devices 60, 62, an individual may engage with the board and board game through a smart phone, which includes an application associated with the Game Board 100. Overall the game board provides a table top alternative for electronic gaming to replace the traditional game board of the prior art.

The Interface Area 50 may be displayed in 3D or holographic format depending on the game being played over the Interface Area 50. The Interface Area 50 may be used to play crossword puzzles, doodle, or even drawing. Also the Interface Area 50 may be configured for use of an Etch A Sketch configuration. As stated, the Interface Area 50 and game board 100 functions on a table top may also include a wireless connection to access software and interactive play with players via an internet connection. As such, the present invention provides a dynamic and complete game board for user consumption. Further numerous educational games may be implemented over the interactive area.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An electronic table top game board comprising:
a. an interface area, where the interface area adapts a predetermined configuration based on user input;
b. player informational displays surrounding the interface area; and
c. a plurality of user interactive devices.

2. The electronic table top game board according to claim 1, where the interface area includes touch interactive protocol.

3. The electronic table top game board according to claim 1, where the plurality of user interactive devices includes touch interactive protocol.

4. The electronic table top game board according to claim 1, further including an alternative controller, where the alternative controller includes a joystick and a plurality of control buttons.

1. An electronic table top game board comprising:
a. an interface area, where the interface area adapts a predetermined configuration based on user input;
b. player informational displays surrounding the interface area; and
c. a plurality of user interactive devices; and
d. an alternative controller, where the alternative controller includes a joystick and a plurality of control buttons.

2. The electronic table top game board according to claim 1, where the interface area includes touch interactive protocol.

3. The electronic table top game board according to claim 1, where the plurality of user interactive devices includes touch interactive protocol.

4. (canceled)
